(19) United States
(12) Patent Application Publication
(10) Pub. No.: US 2005/0150888 A1
(43) Pub. Date: Jul. 14, 2005

(54) Lid for a vase

(76) Inventor: Stephen J. Birkmeier, Delphos, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/758,323

(22) Filed: Jan. 14, 2004

(51) Int. Cl. B65D 39/00; A01G 5/00; A47G 7/00; B65D 25/14

(52) U.S. Cl. 220/229; 220/495.01; 220/801; 47/41.11

(57) ABSTRACT

A lid for a vase including a plate having a top and a bottom extending about a longitudinal axis. An opening extends between the top and the bottom at the longitudinal axis. The lid includes a plurality of movable flaps positioned on the top over the opening. The flaps are movable between a closed position in which the flaps are immediately adjacent one another to limit ingress through the opening to an open position in which the flaps are positioned in the opening to allow an object such as a stem of an artificial flower arrangement to be positioned in the opening. A skirt extends from the bottom about the longitudinal axis.

### BACKGROUND OF THE INVENTION

The present invention relates generally to lid. More specifically, the invention is directed to a lid for a vase such as a cemetery vase.

Prior cemetery vase lids are removed during use to allow for the placement of, for example, fresh and artificial flowers. This allows for the ingress of water and debris. Standing water has been found to be a health concern especially with mosquito breeding. Water and debris in a vase can also cause maintenance problems.

It has been found that there is a need for a lid for a vase that can limit the ingress of water and debris into a vase. There is also a need for a lid that can support objects such as artificial flowers and flagpoles. The present invention satisfies these and other needs.

### SUMMARY OF THE INVENTION

The present invention is a lid for a vase including a plate having a top and a bottom extending about a longitudinal axis. An opening extends between the top and the bottom at the longitudinal axis.

Movable flaps are positioned on the top over the opening. The flaps are movable from a closed position in which the flaps are immediately adjacent on another to limit ingress through the opening to an open position in which the flaps are positioned in the opening to allow an object to be positioned in the opening. A skirt extends from the bottom of the plate about the longitudinal axis.

The primary object of the present invention is to provide a lid for a vase that limits ingress of water and debris into the vase.

An important object of the present invention is to provide a lid for a vase that can support an object.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a side elevational view of a lid for a vase according to the present invention;

FIG. 2 is a top plan view thereof;

FIG. 3 is a bottom plan view thereof;

FIG. 4 is an exploded side elevational view of a lid for a vase including a liner positioned in a cemetery vase with the stem of an artificial flower arrangement extending through the opening of the lid;

FIG. 5 is a side elevational view of a second embodiment lid for a vase according to the present invention;

FIG. 6 is a top plan view thereof;

FIG. 7 is a side elevational view of a third embodiment lid for a vase according to the present invention; and

FIG. 8 is a top plan view thereof.

### DETAILED DESCRIPTION OF THE PREFERRED EMBODIMENTS

The preferred embodiments and best mode of a lid for a vase according to the present invention will now be described in detail with reference being made to the drawings, which constitute a portion of the disclosure. In the drawings, the lid is indicated generally by the reference number “10”.

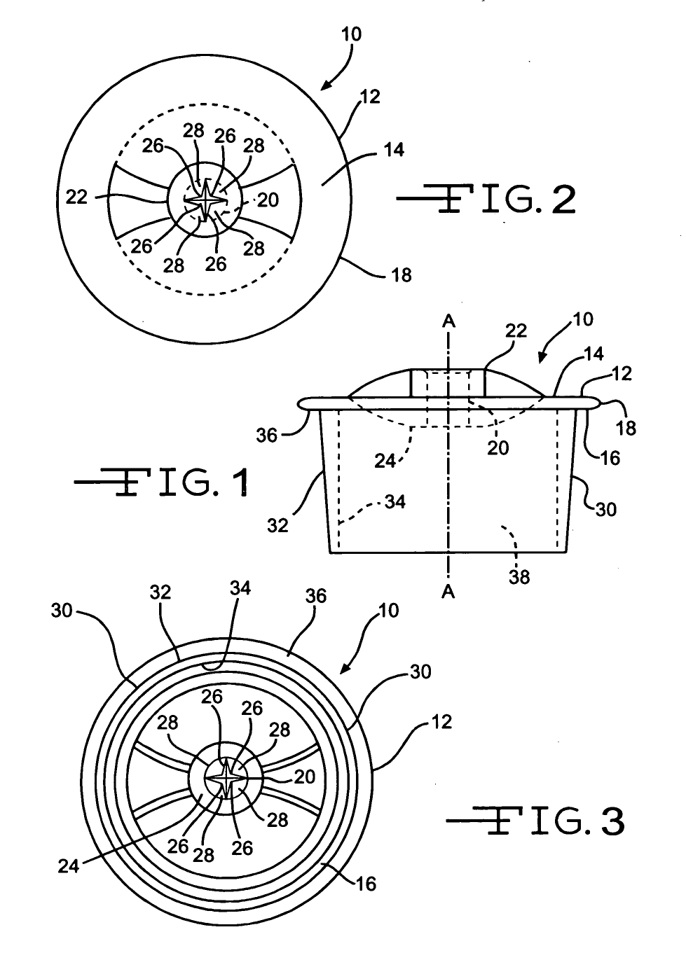

Referring to FIGS. 1-4, the lid 10 includes a circular plate 12 having a top 14 and a bottom 16. The plate 12 includes an outer edge 18. The plate 12 extends about a longitudinal axis A-A.

The lid 10 defines a cylindrical opening 20 extending between the top 14 and the bottom 16 at the longitudinal axis A-A. The plate 12 includes an upper support portion 22 on the top 14 surrounding the opening 20. The plate 12 further includes a lower support portion 24 on the bottom 16 surrounding the opening 20.

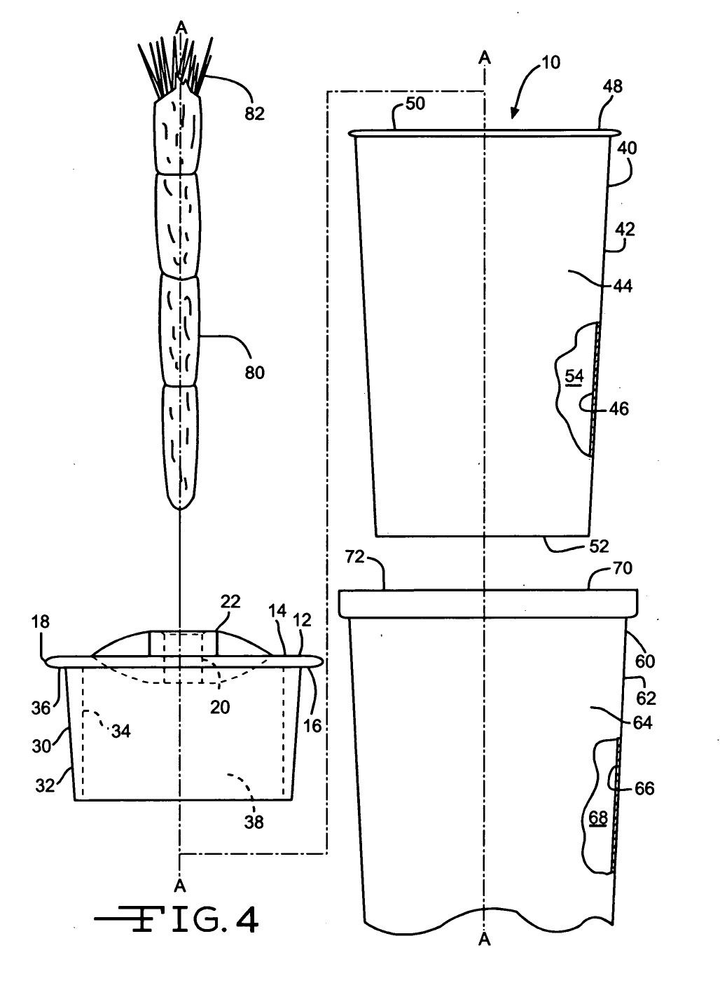

Referring to FIGS. 2 and 3, the lid 10 includes a plurality of movable flaps 26 positioned on the top 14 over the opening 20. In a preferred embodiment, the lid 10 includes four flaps 26. The flaps 26 are movable between a closed position in which the flaps 26 are positioned immediately adjacent one another to an open position in which the flaps 26 are positioned in the opening 20 once an object, as described below, is positioned in the opening 20. Each of the flaps 26 includes an integral support member 28 to provide the flaps 26 with structural integrity. The flaps 26 limit ingress of water and debris through the opening 20 when in the closed position as shown in FIGS. 2 and 3. The flaps 26 also limit ingress when an object is portioned in the opening 20 because they firmly and closely engage the object.

As shown in FIG. 1, the lid 10 includes a cylindrical skirt 30 that extends from the bottom 16 of the plate 12 about the longitudinal axis A-A. The skirt 30 includes an exterior wall 32 and an interior wall 34. The exterior wall 32 is spaced within the outer edge 18 of the plate 12 to provide a flange 36 on the bottom 16 of the plate 12. The interior wall 34 defines an interior void 38 that is in communication with the opening 20.

Referring to FIG. 4, a preferred embodiment lid 10 includes a liner 40 having a cylindrical sidewall 42 that extends about the longitudinal axis A-A. The sidewall 42 includes an outer surface 44 and an inner surface 46. The liner 40 includes an open top 48 having a rim 50 and a closed bottom 52. The inner surface 46 of the sidewall 42 defines an internal void 54.

The lid 10 including the liner 40 is constructed of a suitable plastic material that provides durability and resiliency. The plastic material should be flexible enough to allow the flaps 26 to move from the closed position to the open position during use.

Referring to FIG. 4, the purpose and use of the lid 10 will now be described. The lid 10 is used with, for example, a metal cemetery vase 60. The vase 60 includes a cylindrical sidewall 62 that extends about the longitudinal axis A-A. The sidewall 62 includes an exterior surface 64 and an interior surface 66 that defines an internal space 68. The vase 60 includes an open top 70 having an edge 72. The liner 40 of the lid 10 is positioned in the internal space 68 of the vase 60 through the open top 70. The skirt 30 of the lid 10 is snuggly positioned in the internal void 54 of the liner 40 through the open top 48 of the liner 40. When so positioned, the flange 36 of the plate 12 engages the rim 50 of the liner 40. The flange 36 also engages the edge 72 of the vase 60. This prevents ingress of water and debris into the internal void 54 of the liner 40 and the internal space 68 of the vase 60.

Referring to FIGS. 2 and 4, the movable flaps 26 are in a normally closed position. When in the closed position, the flaps 26 limit ingress of water and debris through the opening 20 into the interior void 38 of the skirt 30 and the internal void 54 of the liner 40.

As shown in FIG. 4, an object such as the stem 80 of an artificial flower arrangement 82 can be driven through the flaps 26 into the opening 20 into the interior void 38 of the skirt 30 and into the internal void 54 of the liner 40. The contact of the stem 80 with the flaps 26 causes them to move inwardly and downwardly into the opening 20. The flaps 26 are supported by the respective support member 28 and the upper and lower support portions 24 of the plate 12. This support positions the stem 80 and thus the artificial flower arrangement 82 in the vase 60 along the longitudinal axis A-A. Other objects can be supported in the lid 10 such as fresh flower arrangements and flagpoles.

Referring to FIGS. 2 and 4, when the stem 80 is removed from the lid 10, the flaps 26 move from the open position to the closed position. The flaps 26 once again limit ingress of water and debris through the opening 20.

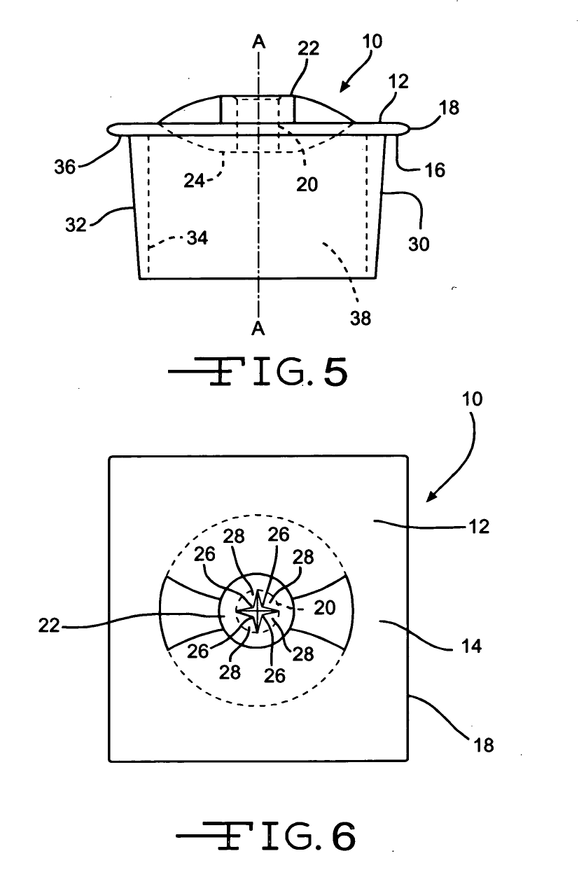

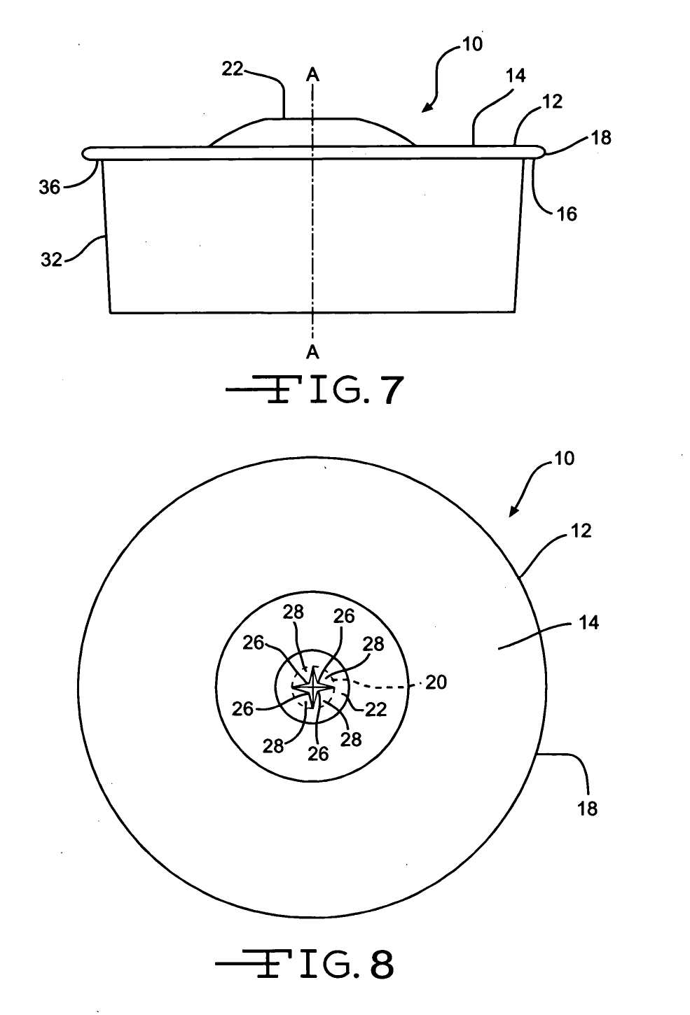

FIGS. 5 and 6 show a second embodiment lid 10 according to the present invention. FIGS. 7 and 8 show a third embodiment lid 10 according to the present invention. The second and third embodiments include the same elements as identified and described above. Therefore, the same reference numbers have been used in FIGS. 5-8 as were used in FIGS. 1-4.

The first embodiment lid 10 as shown in FIGS. 1-3 and the third embodiment lid 10 as shown in FIGS. 7 and 8 include plates 12 having circular configurations. These circular configurations are used with vases 30 having corresponding circular configurations. The second embodiment lid 10 as shown in FIGS. 7 and 8 includes a plate 12 having a rectangular configuration such as the square configuration shown in the drawings. A rectangular configuration is used with a vase 30 having a corresponding rectangular configuration.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

1. A lid for a vase comprising:
a plate having a top and a bottom extending about a longitudinal axis;
an opening extending between said top and said bottom at said longitudinal axis;
a plurality of movable flaps positioned on said top over said opening, said flaps being movable between a closed position in which said flaps are immediately adjacent one another to an open position in which said flaps are positioned in said opening to allow an object to be positioned in said opening; and
a skirt extending from said bottom about said longitudinal axis.

2. The lid of claim 1 wherein said plate has an upper support portion on said top surrounding said opening.

3. The lid of claim 1 wherein said plate has a lower support portion on said bottom surrounding said opening.

4. The lid of claim 1 wherein each of said flaps includes an integral support member.

5. The lid of claim 1 wherein said lid further comprises a liner having a rim and an internal void, said bottom of said plate being positioned on said rim and said skirt being positioned in said internal void.

6. The lid of claim 1 wherein said plate has a generally circular configuration.

7. The lid of claim 1 wherein said plate has a generally rectangular configuration.

8. The lid of claim 1 wherein said-lid is comprised of plastic.

9. The lid of claim 5 wherein said lid is comprised of plastic.
